(19) United States
(12) Patent Application Publication
(10) Pub. No.: US 2024/0224283 A1
(43) Pub. Date: Jul. 4, 2024

(54) TERMINAL, RADIO COMMUNICATION SYSTEM AND RADIO COMMUNICATION METHOD

(71) Applicant: NTT DOCOMO, INC., Tokyo (JP)

(72) Inventors: Yuki Takahashi, Tokyo (JP); Satoshi Nagata, Tokyo (JP); Qiping Pi, Beijing (CN); Jing Wang, Beijing (CN); Lan Chen, Beijing (CN)

(73) Assignee: NTT DOCOMO, INC., Tokyo (JP)

(21) Appl. No.: 18/286,703

(22) PCT Filed: Mar. 30, 2022
(86) PCT No.: PCT/JP2022/016196

§ 371 Date: Oct. 12, 2023

(30) Foreign Application Priority Data
Apr. 13, 2021 (JP) 2021-067985

(51) Int. Cl. H04W 72/21; H04W 72/232; H04W 72/566; H04W 76/20

(52) U.S. Cl. CPC H04W 72/21; H04W 72/232; H04W 72/566; H04W 76/20

(57) ABSTRACT

A terminal includes a control unit that multiplexes two or more uplink control information having different priorities on an uplink channel; and a communication unit that transmits an uplink signal using the uplink channel on which the two or more uplink control information is multiplexed, wherein the control unit determines a coding unit of the two or more uplink control information based on a specific condition.

### TECHNICAL FIELD

The present disclosure relates to a terminal, a radio communication system and a radio communication method for performing radio communication, in particular, a terminal, a radio communication system and a radio communication method related to multiplexing uplink control information for an uplink channel.

### BACKGROUND ART

The 3rd Generation Partnership Project (3GPP) has specified the 5th generation mobile communication system (Also called 5G, New Radio (NR), or Next Generation (NG)) and is also in the process of specifying the next generation called Beyond 5G, 5G Evolution or 6G.

Release 15 of 3GPP supports simultaneous transmission of two or more uplink channels (PUCCH(Physical Uplink Control Channel) and PUSCH (Physical Uplink Shared Channel)) transmitted in the same slot.

In addition, Release 17 of 3GPP agreed to support multiplexing Uplink Control Information (UCI) with different priorities into PUSCH (For example, Non-Patent Literature 1).

### CITATION LIST

### Non-Patent Literature

### Non-Patent Literature 1

“Enhanced Industrial Internet of Things (IOT) and ultra-reliable and low latency communication,” RP-201310, 3GPP TSG RAN Meeting #86e, 3GPP, July 2020

### SUMMARY OF INVENTION

### [Issues to be Solved by the Invention]

Against this background, the inventors, etc. found, as a result of careful examination, the necessity of appropriately determining the coding units of UCIs having different priorities in the multiplex of different UCIs.

Accordingly, the present invention has been made in view of such a situation, and it is an object of the present invention to provide a terminal, a radio communication system, and a radio communication method capable of appropriately determining a coding unit of a UCI having different priorities in a multiplex of different UCIs.

### Means for Solving the Problem

An aspect of the present disclosure is a terminal comprising: a control unit that multiplexes two or more uplink control information having different priorities on an uplink channel; and a communication unit that transmits an uplink signal using the uplink channel on which the two or more uplink control information is multiplexed; wherein the control unit determines a coding unit of the two or more uplink control information based on a specific condition.

An aspect of the present disclosure is a radio communication system comprising: a terminal; and a base station; wherein the terminal comprises: a control unit that multiplexes two or more uplink control information having different priorities on an uplink channel; and a communication unit that transmits an uplink signal using the uplink channel on which the two or more uplink control information is multiplexed; wherein the control unit determines a coding unit of the two or more uplink control information based on a specific condition.

An aspect of the present disclosure is a radio communication method comprising: a step A of multiplexing two or more uplink control information having different priorities on an uplink channel; and a step B of transmitting an uplink signal using the uplink channel on which the two or more uplink control information is multiplexed; wherein the step A includes a step of determining a coding unit of the two or more uplink control information based on a specific condition.

### BRIEF DESCRIPTION OF DRAWINGS

FIG. 1 is a general schematic diagram of the radio communication system 10.

FIG. 2 is a diagram showing the frequency range used in the radio communication system 10.

FIG. 3 is a diagram showing a configuration example of a radio frame, a sub-frame and a slot used in the radio communication system 10.

FIG. 4 is a functional block configuration diagram of the UE200.

FIG. 5 is a functional block configuration diagram of the gNB100.

FIG. 6 is a diagram for explaining rate matching.

FIG. 7 is a diagram for explaining rate matching.

FIG. 8 is a diagram for explaining rate matching.

FIG. 9 is a diagram for explaining the Pattern of the UCI coding part.

FIG. 10 is a diagram for explaining the Pattern of the UCI coding part.

FIG. 11 is a diagram for explaining the Pattern of the UCI coding part.

FIG. 12 is a diagram for explaining the Pattern of the UCI coding part.

FIG. 13 is a diagram for explaining the Pattern of the UCI coding part.

FIG. 14 is a diagram for explaining the Pattern of the UCI coding part.

FIG. 15 is a diagram for explaining the Pattern of the UCI coding part.

FIG. 16 is a diagram for explaining the Pattern of the UCI coding part.

FIG. 17 is a diagram for explaining the Pattern of the UCI coding part.

FIG. 18 is a diagram for explaining the Pattern of the UCI coding part.

FIG. 19 is a diagram for explaining the Pattern of the UCI coding part.

FIG. 20 is a diagram for explaining the Pattern of the UCI coding part.

FIG. 21 is a diagram for explaining the Pattern of the UCI coding part.

FIG. 22 is a diagram for explaining the Pattern of the UCI coding part.

FIG. 23 is a diagram for explaining the Pattern of the UCI coding part.

FIG. 24 is a diagram for explaining the Pattern of the UCI coding part.

FIG. 25 is a diagram showing an example of the hardware configuration of the gNB100 and the UE200.

### MODES FOR CARRYING OUT THE INVENTION

Exemplary embodiments of the present invention are explained below with reference to the accompanying drawings. The same functions and configurations are denoted by the same or similar reference numerals, and their descriptions are omitted accordingly.

### Embodiment

### (1) Overall Schematic Configuration of the Radio Communication System

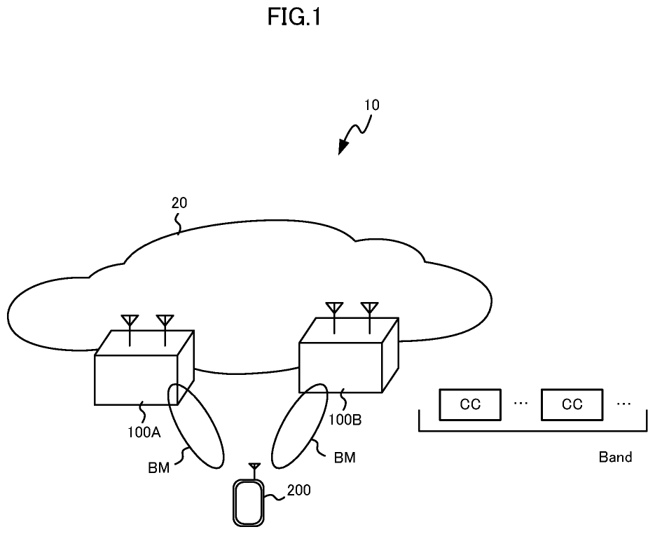

FIG. 1 is an overall schematic configuration diagram of a radio communication system 10 according to an embodiment. The radio communication system 10 is a radio communication system according to 5G New Radio (NR) and includes a Next Generation-Radio Access Network 20 (hereinafter referred to as NG-RAN20 and a terminal 200 (UE (User Equipment) 200).

The radio communication system 10 may be a radio communication system according to a system called Beyond 5G, 5G Evolution or 6G.

The NG-RAN20 includes a radio base station 100 A (gNB100 A) and a radio base station 100B (gNB100B). The specific configuration of the radio communication system 10 including the number of gNBs and UEs is not limited to the example shown in FIG. 1.

The NG-RAN20 actually includes a plurality of NG-RAN Nodes, specifically gNBs (or ng-eNBs), connected to a core network (5GC, not shown) according to 5G. Note that the NG-RAN20 and 5 GCs may be simply described as “networks”.

The gNB100 A and gNB100B are radio base stations in accordance with 5G, and perform radio communications in accordance with the UE200 and 5G. The gNB100 A, gNB100B, and UE200 can support Massive MIMO (Multiple-Input Multiple-Output), which generates a more directional beam BM by controlling radio signals transmitted from multiple antenna elements; Carrier Aggregation (CA), which uses multiple component carriers (CCs) bundled together; and Dual Connectivity (DC), which communicates with two or more transport blocks simultaneously between the UE and each of two NG-RAN Nodes.

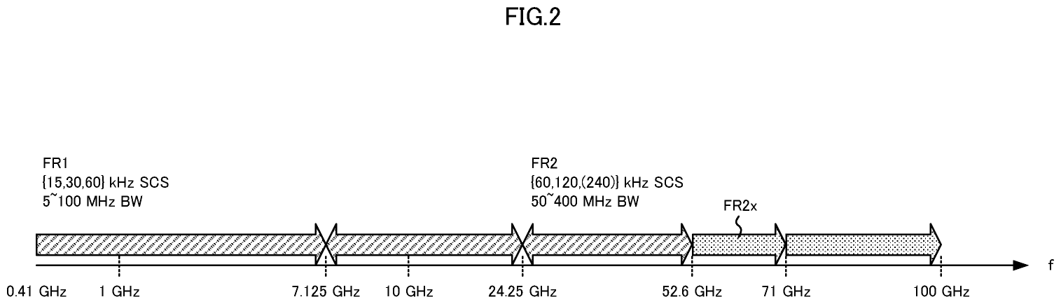

The radio communication system 10 also supports multiple frequency ranges (FRs). FIG. 2 shows the frequency ranges used in the radio communication system 10.

As shown in FIG. 2, the radio communication system 10 corresponds to FR1 and FR2. The frequency bands of each FR are as follows.
FR1:410 MHz˜7.125 GHz • FR2:24.25 GHz˜52.6 GHz FR1 uses 15, 30 or 60 kHz sub-carrier spacing (SCS) and may use a 5˜100 MHz bandwidth (BW). FR2 is higher frequency than FR1 and may use 60 or 120 kHz (may include 240 kHz) SCS and may use a 50˜400 MHz bandwidth (BW).

SCS may be interpreted as numerology. Numerology is defined in 3GPP TS38.300 and corresponds to one subcarrier spacing in the frequency domain.

In addition, the radio communication system 10 corresponds to a higher frequency band than the FR2 frequency band. Specifically, the radio communication system 10 corresponds to a frequency band above 52.6 GHz and up to 71 GHz or 114.25 GHz. Such a high frequency band may be referred to as “FR 2 x” for convenience.

In order to solve the problem that the influence of phase noise increases in the high frequency band, a cyclic prefix-orthogonal frequency division multiplexing (CP-OFDM)/discrete Fourier transform-spread (DFT-S-OFDM) with larger sub-carrier spacing (SCS) may be applied when a band exceeding 52.6 GHz is used.

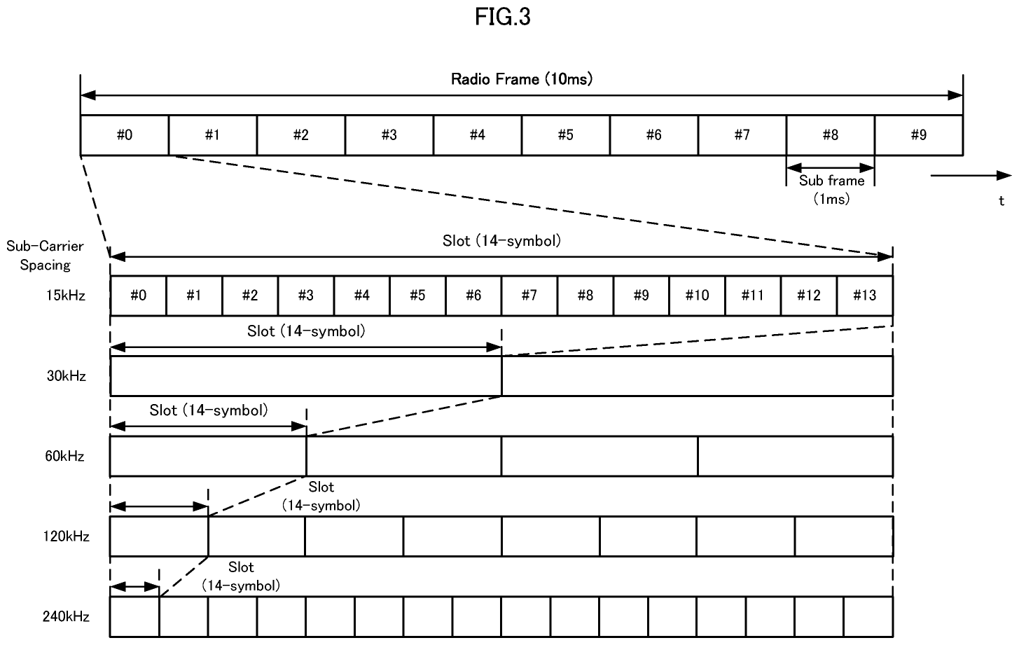

FIG. 3 shows a configuration example of a radio frame, sub-frame and slot used in the radio communication system 10.

As shown in FIG. 3, one slot is composed of 14 symbols, and the larger (wider) the SCS, the shorter the symbol period (and slot period). The SCS is not limited to the interval (frequency) shown in FIG. 3. For example, 480 kHz, 960 kHz, and the like may be used.

The number of symbols constituting 1 slot may not necessarily be 14 symbols (For example, 28, 56 symbols). Furthermore, the number of slots per subframe may vary depending on the SCS.

Note that the time direction (t) shown in FIG. 3 may be referred to as a time domain, symbol period, symbol time, etc. The frequency direction may be referred to as a frequency domain, resource block, subcarrier, bandwidth part (BWP), etc.

A DMRS is a type of reference signal and is prepared for various channels. In this context, unless otherwise specified, a DMRS for a downlink data channel, specifically a PDSCH (Physical Downlink Shared Channel), may be used. However, a DMRS for an uplink data channel, specifically a PUSCH (Physical Uplink Shared Channel), may be interpreted in the same way as a DMRS for a PDSCH.

The DMRS may be used for channel estimation in a device, e.g., UE200, as part of a coherent demodulation. The DMRS may be present only in the resource block (RB) used for PDSCH transmission.

The DMRS may have more than one mapping type. Specifically, the DMRS may have a mapping type A and a mapping type B. In a mapping type A, the first DMRS is located in the second or third symbol of the slot. In a mapping type A, the DMRS may be mapped relative to the slot boundary regardless of where the actual data transmission is initiated in the slot. The reason why the first DMRS is placed in the second or third symbol of the slot may be interpreted as placing the first DMRS after the control resource sets (CORESET).

In mapping type B, the first DMRS may be placed in the first symbol of the data allocation. That is, the location of the DMRS may be given relative to where the data is located, rather than relative to the slot boundary.

The DMRS may also have more than one type. Specifically, the DMRS may have Type 1 and Type 2. Type 1 and Type 2 differ in the maximum number of mapping and orthogonal reference signals in the frequency domain. Type 1 can output up to four orthogonal signals in single-symbol DMRS, and Type 2 can output up to eight orthogonal signals in double-symbol DMRS.
(2) Radio communication system functional block configuration Next, a functional block configuration of the radio communication system 10 will be described.

First, a functional block configuration of the UE200 will be described.

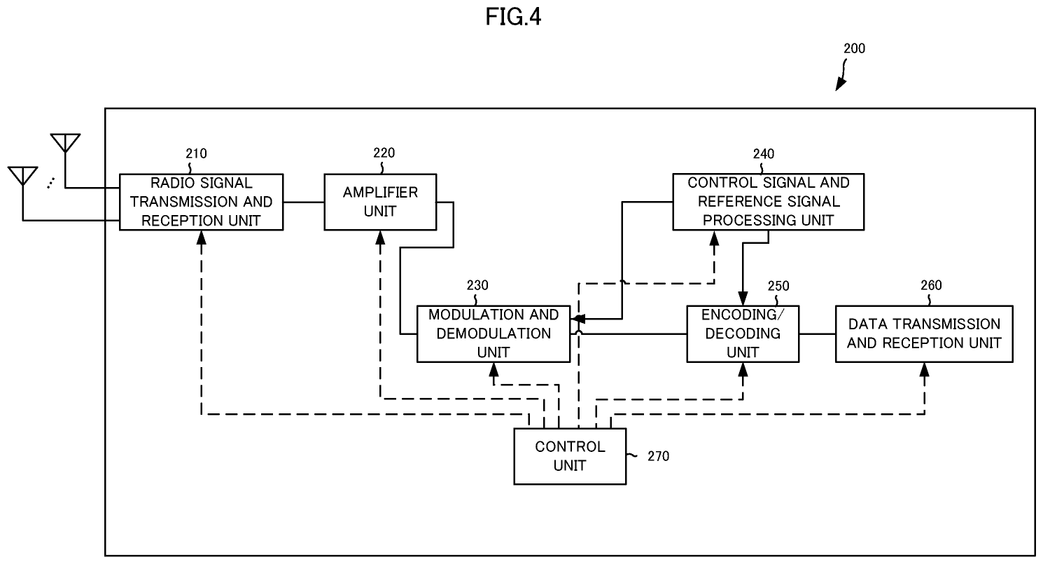

FIG. 4 is a functional block configuration diagram of the UE200. As shown in FIG. 4, the UE200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

The radio signal transmission and reception unit 210 transmits and receives radio signals in accordance with the NR. The radio signal transmission and reception unit 210 corresponds to a Massive MIMO, a CA using a plurality of CCs bundled together, and a DC that simultaneously communicates between a UE and each of two NG-RAN Nodes.

The amplifier unit 220 is composed of a PA (Power Amplifier)/LNA (Low Noise Amplifier) or the like. The amplifier unit 220 amplifies the signal output from the modulation and demodulation unit 230 to a predetermined power level. The amplifier unit 220 amplifies the RF signal output from the radio signal transmission and reception unit 210.

The modulation and demodulation unit 230 performs data modulation/demodulation, transmission power setting, resource block allocation, etc. for each predetermined communication destination (gNB100 or other gNB). Cyclic Prefix-Orthogonal Frequency Division Multiplexing (CP-OFDM)/Discrete Fourier Transform-Spread (DFT-S-OFDM) may be applied to the modulation and demodulation unit 230. DFT-S-OFDM may be used not only for the uplink (UL) but also for the downlink (DL).

The control signal and reference signal processing unit 240 performs processing related to various control signals transmitted and received by the UE200 and various reference signals transmitted and received by the UE200.

Specifically, the control signal and reference signal processing unit 240 receives various control signals transmitted from the gNB100 via a predetermined control channel, for example, a radio resource control layer (RRC) control signal. The control signal and reference signal processing unit 240 also transmits various control signals to the gNB100 via a predetermined control channel.

The control signal and reference signal processing unit 240 executes processing using a reference signal (RS) such as a demodulation reference signal (DMRS) and a phase tracking reference signal (PTRS).

The DMRS is a known reference signal (pilot signal) between a base station and a terminal of each terminal for estimating a fading channel used for data demodulation. The PTRS is a reference signal of each terminal for estimating phase noise, which is a problem in a high frequency band.

In addition to the DMRS and the PTRS, the reference signal may include a Channel State Information-Reference Signal (CSI-RS), a Sounding Reference Signal (SRS), and a Positioning Reference Signal (PRS) for position information.

The channel may include a control channel and a data channel. The control channel may include PDCCH (Physical Downlink Control Channel), PUCCH(Physical Uplink Control Channel), RACH(Random Access Channel), Downlink Control Information (DCI) including Random Access Radio Network Temporary Identifier (RA-RNTI), and Physical Broadcast Channel (PBCH).

The data channel may also include PDSCH (Physical Downlink Shared Channel) and PUSCH (Physical Uplink Shared Channel). Data means data transmitted over a data channel. A data channel may be read as a shared channel.

Here, the control signal and reference signal processing unit 240 may receive downlink control information (DCI). The DCI includes existing fields for storing DCI Formats, Carrier indicator (CI), BWP indicator, Frequency Domain Resource Assignment (FDRA), Time Domain Resource Assignment (TDRA), Modulation and Coding Scheme (MCS), HPN (HARQ Process Number), New Data Indicator (NDI), Redundancy Version (RV), and the like.

The value stored in the DCI Format field is an information element that specifies the format of the DCI. The value stored in the CI field is an information element that specifies the CC to which the DCI applies. The value stored in the BWP indicator field is an information element that specifies the BWP to which the DCI applies. The BWP that can be specified by the BWP indicator is set by an information element (BandwidthPart-Config) contained in the RRC message. The value stored in the FDRA field is an information element that specifies the frequency domain resource to which the DCI applies. The frequency domain resource is specified by the value stored in the FDRA field and the information element (RA Type) contained in the RRC message. The value stored in the TDRA field is the information element that specifies the time domain resource to which the DCI is applied. The time domain resource is identified by the value stored in the TDRA field and the information element (pdsch-TimeDomainAllocationList, pusch-TimeDomainAllocationList) contained in the RRC message. The time domain resource may be identified by the value stored in the TDRA field and the default table. The value stored in the MCS field is an information element that specifies the MCS to which the DCI applies. The MCS is specified by the value stored in the MCS and the MCS table. The MCS table may be specified by an RRC message or specified by RNTI scrambling. The value stored in the HPN field is an information element that specifies the HARQ Process to which the DCI is applied. The value stored in the NDI is an information element that identifies whether the data to which the DCI is applied is first-time data. The value stored in the RV field is an information element that specifies the redundancy of the data to which the DCI is applied.

The encoding/decoding unit 250 performs data partitioning/concatenation and channel coding/decoding for each predetermined communication destination (gNB100 or other gNB).

Specifically, the encoding/decoding unit 250 divides the data output from the data transmission and reception unit 260 into predetermined sizes and performs channel coding on the divided data. The encoding/decoding unit 250 decodes the data output from the modulation and demodulation unit 230 and concatenates the decoded data.

The data transmission and reception unit 260 transmits and receives the protocol data unit (PDU) and the service data unit (SDU). Specifically, the data transmission and reception unit 260 performs assembly/disassembly of the PDU/SDU in a plurality of layers (Media access control layer (MAC), radio link control layer (RLC), packet data convergence protocol layer (PDCP), etc.). The data transmission and reception unit 260 also performs error correction and retransmission control of data based on HARQ (Hybrid Automatic Repeat Request).

The control unit 270 controls each function block constituting the UE200. In the embodiment, the control unit 270 constitutes a control unit that multiplexes two or more uplink control information (UCI) having different priorities on the uplink channel (PUSCH).

The first priority and the second priority may be assumed as the priority of PUSCH and UCI. The first priority is different from the second priority. Two types of priority for PUSCH and UCI are illustrated: HP (High Priority) and LP (Low Priority). The first priority may be HP, the second priority may be LP, the first priority may be LP, and the second priority may be HP. Three or more types of priorities may be specified as UCI priorities.

Under these assumptions, the control unit 270 determines the coding units (UCI coding part) of two or more UCIs with different priorities based on specific conditions.

The UCI may include an acknowledgment (HARQ-ACK) for one or more TBs. The UCI may include a scheduling request (SR) requesting scheduling of the resource, or a channel state information (CSI) representing the state of the channel.

Note that the control unit 270 controls the control signal and reference signal processing unit 240 described above, and the control signal and reference signal processing unit 240 may comprise a communication unit for transmitting an uplink signal via a PUSCH in which two or more UCIs are multiplexed.

Second, a functional block configuration of the gNB100 will be described.

FIG. 5 is a functional block configuration diagram of the gNB100. As shown in FIG. 5, the gNB100 has a reception unit 110, a transmission unit 120, and a control unit 130.

The reception unit 110 receives various signals from the UE200. The reception unit 110 may receive a UL signal via PUCCH or PUSCH.

The transmission unit 120 transmits various signals to UE200. The transmission unit 120 may transmit DL signals via PDCCH or PDSCH.

The control unit 130 controls gNB100. The control unit 130 may assume that 2 or more UCIs are multiplexed on PUSCH in the UCI coding part determined based on specific conditions. The control unit 130 may assume that 2 or more UCIs are multiplexed on PUSCH for receiving uplink signals. For example, the control unit 130 may assume that the PUSCH receives multiplexed UCIs when the information element it transmits to UE200 explicitly or implicitly indicates activation. The control unit 130 may not assume that the PUSCH receives multiplexed UCIs when the information element it transmits to UE200 explicitly or implicitly indicates invalidation.

### (3) Rate Matching

Rate matching will be described below. Specifically, rate matching of UCI in the case where UCI is multiplexed on UL SCH will be described. HARQ-ACK, CSI Unit 2, and CSI Unit 2 will be exemplified as UCI. HARQ-ACK, CSI Unit 2, and CSI Unit 2 will be executed separately.

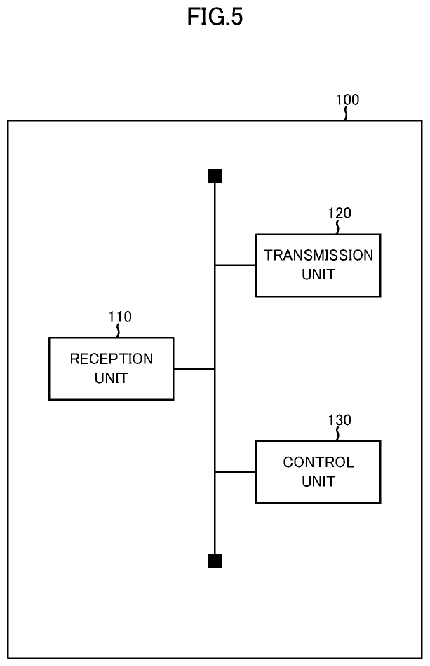

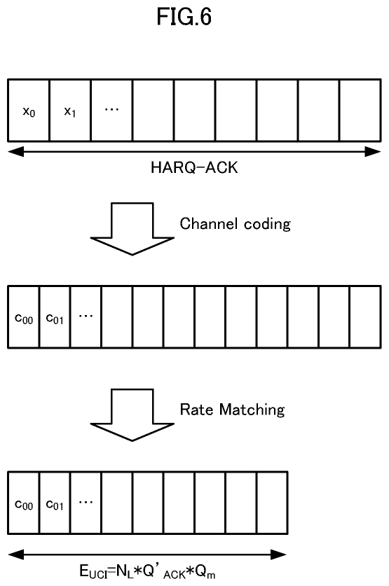

As shown in FIG. 6, when channel coding is applied to HARQ-ACK having bit sequences of “X₀, X₁, . . . ”, bit sequences of “C00, C01, . . . ” are obtained. Rate matching is applied to such bit sequences. The bit sequence (E_{UCI}) after rate matching may be represented by E_{UCI}=N_{L}×Q′_{AC}×Qₘ.

N_{L} is the number of transmit layers in PUSCH. Qₘ is the modulation condition of PUSCH. For example, Q′_{ACK} is expressed by the following equation (TS38.212 V 16.3.0 § 6.3.2.4.1.1 “HARQ-ACK”):

$${Q}_{ACK}^{′} = min \{ ⌈ \frac{( {0}_{ACK} + {L}_{ACK} ) \cdot {β}_{offset}^{PUSCH} \cdot {\sum }_{l = 0}^{{N}_{symb , all}^{PUSCH} - 1} {M}_{s c}^{UCI} ( l )}{{\sum }_{r = 0}^{{C}_{UL - SCH - 1}} {K}_{r}} ⌉ , ⌈ α \cdot {\sum }_{l = 0}^{{N}_{symb , all}^{PUSCH} - 1} {M}_{s c}^{UCI} ( l ) ⌉ \} \qquad [ Equation 1 ]$$

O_{ACK} is the number of bits of HARQ-ACK.
L_{ACK} is the number of bits of CRC applied for HARQ-ACK.
β_{offset}^{PUSCH} is β_{offset}^{HARQ-ACK}, ββ_{offset}^{HARQ-ACK} is an example of the coefficient (β) multiplied to the number of bits constituting HARQ-ACK.
M_{sc}^{UCI}(l) is a bandwidth scheduled for PUSCH transmission, and is expressed by the number of subcarriers.
C_{UL-SCH} is the number of code blocks for UL-SCH of PUSCH transmission.
α is an example of the scaling factor multiplied to the radio resource (here, M_{sc}^{UCI}(l)) which can be used for the transmission of UCI.

Note that Q′_{ACK} is the minimum value of the item defined by the factor (β) (left side) and the item defined by the scaling factor (α) (right side). Therefore, it should be noted that the RE (Resource Element) used to transmit the HARQ-ACK may be limited by the scaling factor (α).

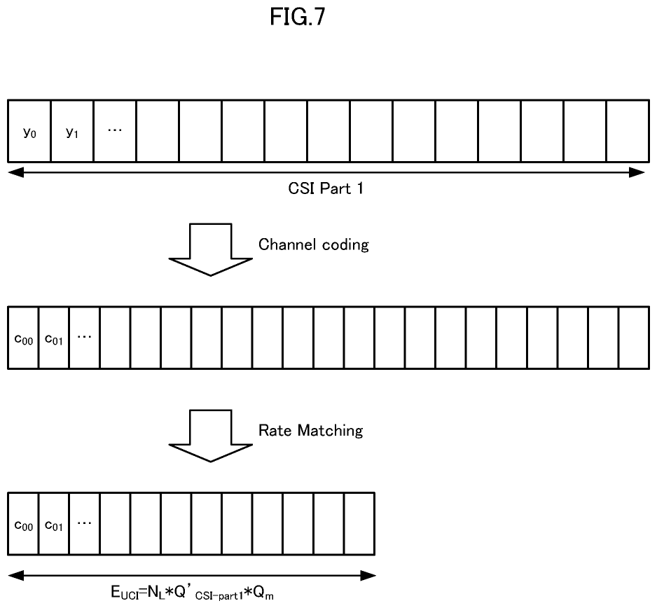

As shown in FIG. 7, when channel coding is applied to CSI Unit 1 having bit sequences of “Y₀, Y₁, . . . ”, bit sequences of “C00, C01, . . . ” are obtained. Rate matching is applied to such bit sequences. The bit sequence (E_{UCI}) after rate matching may be represented by E_{UCI}=N_{L}×Q′_{CSI-part1}×Qₘ.

N_{L} is the number of transmit layers of the PUSCH. Qₘ is the modulation condition of the PUSCH. For example, Q′_{CSI-part1} is expressed by the following equation (TS38.212 V 16.3.0 § 6.3.2.4.1.2 “CSI part1”).

$${Q}_{CSI - 1}^{′} = min \{ \begin{matrix}⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK / CGI - UCI}^{′}\end{matrix} \} \qquad [ Equation 2 ]$$

O_{CSI-1} is the number of bits of CSI Part 1.
L_{CSI-1} is the number of bits of CRC applied for CSI Part 1.
β_{offset}^{PUSCH} is β_{offset}^{CSI-part1}, and β_{offset}^{CSI-part1} is an example of the coefficient (β) multiplied to the number of bits constituting CSI Part 1.
M_{sc}^{UCI}(l) is a bandwidth scheduled for PUSCH transmission, and is expressed by the number of subcarriers.
C_{UL-SCH} is the number of code blocks for UL-SCH of PUSCH transmission.
α is an example of the scaling factor multiplied to the radio resource (here, M_{sc}^{UCI}(l)) which can be used for the transmission of UCI.

Note that Q′_{ACK} is the minimum value of the item defined by the factor (β) (left side) and the item defined by the scaling factor (α) (right side). Therefore, it should be noted that the RE (Resource Element) used to transmit CSI Unit 1 may be limited by the scaling factor (α).

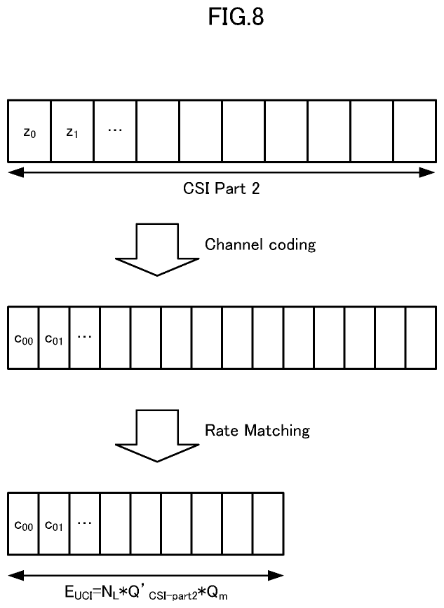

As shown in FIG. 8, the bit sequences “C00, C01, . . . ” are obtained by applying channel coding to CSI Unit 2 having the bit sequences “Z0, Z1, . . . ”. Rate matching is applied to such bit sequences. The bit sequence (E_{UCI}) after rate matching may be represented by E_{UCI}=N_{L}×Q′_{CSI-part2}×Qₘ.

N_{L} is the number of transmit layers of the PUSCH. Qₘ is the modulation condition of PUSCH. For example, Q′_{CSI-part2} is expressed by the following equation (TS38.212 V 16.3.0 § 6.3.2.4.1.3 “CSI part2”).

$${Q}_{CSI - 2}^{′} = min \{ \begin{matrix}⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK / CGI - UCI}^{′} - {Q}_{CSI - 1}^{′}\end{matrix} \} \qquad [ Equation 3 ]$$

O_{CSI-2} is the number of bits of CSI Part 2.
L_{CSI-2} is the number of bits of CRC applied for CSI Part 2.
β_{offset}^{PUSCH} is β_{offset}^{CSI-part2}, and β_{offset}^{CSI-part2} is an example of the coefficient (β) multiplied to the number of bits constituting CSI Part 2.
M_{sc}^{UCI}(l) is a bandwidth scheduled for PUSCH transmission, and is expressed by the number of subcarriers.
C_{UL-SCH} is the number of code blocks for UL-SCH of PUSCH transmission.
α is an example of the scaling factor multiplied to the radio resource (here, M_{sc}^{UCI}(l)) which can be used for the transmission of UCI.

Note that Q′_{ACK} is the minimum value of the item defined by the factor (β) (left side) and the item defined by the scaling factor (α) (right side). Therefore, it should be noted that the RE (Resource Element) used to transmit CSI Unit 2 may be limited by the scaling factor (α).

### (4) Coding Units

The coding unit (UCI coding part) of the embodiment will be described below. In the following example, HP HARQ-ACK, LP HARQ-ACK, HP CSI Unit 1, LP CSI Unit 1, HP CSI Unit 2 and LP CSI Unit 1 are multiplexed as UCIs. However, UCIs of one or more of HP HARQ-ACK, LP HARQ-ACK, HP CSI Unit 1, LP CSI Unit 1, HP CSI Unit 2 and LP CSI Unit 1 need not be multiplexed.

Here, HP and LP mean priority of UCIs. When both HP and LP are the same, the priority of HARQ-ACK may be considered higher than that of CSI Unit 1, and the priority of CSI Unit 1 may be considered higher than that of CSI Unit 2.

HARQ-ACK, CSI Unit 1 and CSI Unit 2 refer to the type of UCI. CSI Unit 1 may be treated as the same type as CSI Unit 2. If CSI of one part is multiplexed, it may be assumed that CSI Unit 2 does not exist and CSI Unit 1 is multiplexed.

Under these assumptions, UE200 determines the UCI coding part of 2 or more UCIs based on specific conditions. The UCI coding part is defined based on at least one of the respective priorities of 2 or more UCIs multiplexed on PUSCH and the respective types of 2 or more UCIs multiplexed on PUSCH.

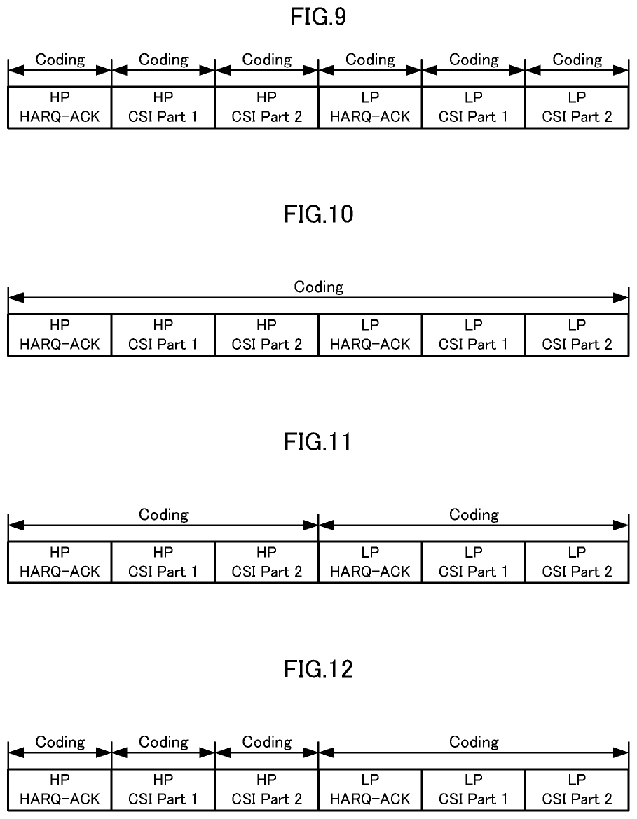

First, the case where the UCI coding part is defined primarily based on the respective priorities of 2 or more UCIs multiplexed on PUSCH will be described. In such a case, 2 or more UCIs are ordered based on the priority of the UCI and separated into UCI coding parts as shown in FIGS. 9 to 16. Specifically, UCIs multiplexed in PUSCH are ordered in the order of HP HARQ-ACK, HP CSI Unit 1, HP CSI Unit 2, LP HARQ-ACK, LP CSI Unit 1 and LP CSI Unit 1 and separated into UCI coding parts.

As shown in FIG. 9, UCI coding parts may be defined as a unit for each UCI (Pattern 1-1). Specifically, HP HARQ-ACK, HP CSI Unit 1, HP CSI Unit 2, LP HARQ-ACK, LP CSI Unit 1 and LP CSI Unit 1 are coded separately. That is, the UCI multiplexed on the PUSCH is divided into six parts with a maximum of five partitions. Such coding may be referred to as separate coding.

As shown in FIG. 10, a UCI coding part may be defined with all UCIs as one unit (Pattern 1-2). Specifically, HP HARQ-ACK, HP CSI Unit 1, HP CSI Unit 2, LP HARQ-ACK, LP CSI Unit 1 and LP CSI Unit 1 are coded integrally. That is, the UCI multiplexed on the PUSCH is treated as one part without being separated. Such coding may be called joint coding.

As shown in FIG. 11, the UCI coding part may be defined as a unit for each HP and LP priority (Pattern 1-3). Specifically, HP HARQ-ACK, HP CSI Unit 1, and HP CSI Unit 2 are integrally coded as one part, and LP HARQ-ACK, LP CSI Unit 1, and LP CSI Unit 1 are integrally coded as one part. That is, the UCI multiplexed on the PUSCH is divided into two parts at a single point. Such coding may be considered a kind of separate coding, a kind of joint coding, or a combination of separate coding and joint coding.

As shown in FIG. 12, the UCI coding part may be defined as a unit for each UCI for HP UCIs and as a unit for all UCIs for LP UCIs (Pattern 1-4). Specifically, HP HARQ-ACK, HP CSI Unit 1 and HP CSI Unit 2 are coded separately, and LP HARQ-ACK, LP CSI Unit 1 and LP CSI Unit 1 are coded integrally as one part. That is, the UCI multiplexed in PUSCH is divided into four parts with a maximum of three separations. Such coding may be considered a kind of separate coding, a kind of joint coding, or a combination of separate coding and joint coding.

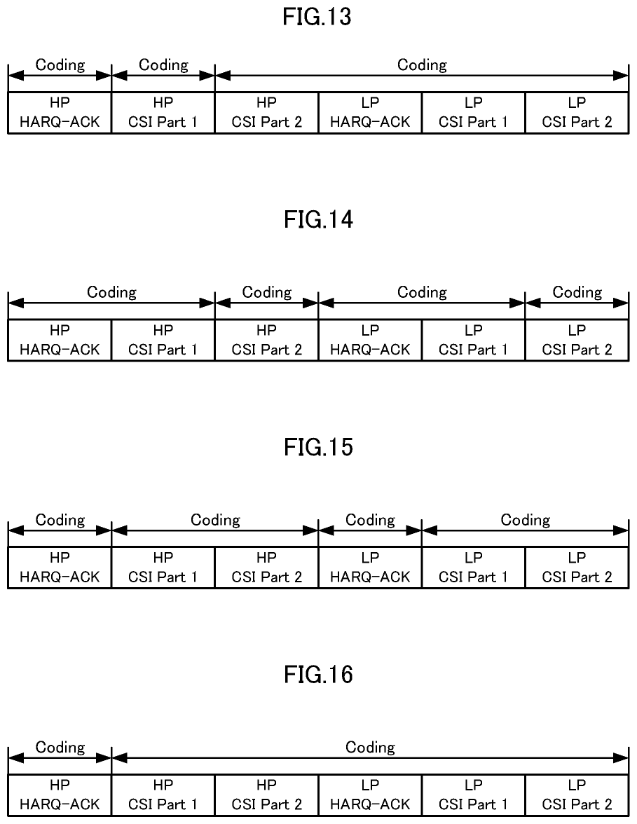

As shown in FIG. 13, the UCI coding part may be defined for HP UCI as a unit per UCI, and for LP UCI as a unit of the least preferred HP UCI (the last HP UCI) (Pattern 1-5). Specifically, HP HARQ-ACK and HP CSI Unit 1 are coded separately, and HP CSI Unit 2, LP HARQ-ACK, LP CSI Unit 1, and LP CSI Unit 1 are coded integrally as one part. That is, the UCI multiplexed on the PUSCH is divided into three parts with a maximum of two partitions. Such coding may be considered a kind of separate coding, a kind of joint coding, or a combination of separate coding and joint coding.

As shown in FIG. 14, the UCI coding part may be HARQ-ACK and CSI Unit 1 defined as one unit, CSI Unit 2 defined as one unit, and HP and LP defined as separate units (Pattern 1-6). Specifically, HP HARQ-ACK and HP CSI Unit 1 are coded integrally as one part, and HP CSI Unit 2 is coded independently. Similarly, LP HARQ-ACK and LP CSI Unit 1 are coded integrally as one part, and LP CSI Unit 2 is coded independently. That is, the UCI multiplexed in PUSCH is divided into four parts with at most three separations. Such coding may be considered a kind of separate coding, a kind of joint coding, or a combination of separate coding and joint coding.

As shown in FIG. 15, the UCI coding part may be defined as follows: HARQ-ACK is defined as one unit, CSI Unit 1 and CSI Unit 2 are defined as one unit, and HP and LP are defined as separate units (Pattern 1-7). Specifically, HP HARQ-ACK is coded independently, and HP CSI Unit 1 and HP CSI Unit 2 are coded integrally as one part. Similarly, LP HARQ-ACK is coded independently, and LP CSI Unit 1 and LP CSI Unit 2 are coded integrally as one part. That is, the UCI multiplexed in PUSCH is divided into four parts with at most three separations. Such coding may be considered a kind of separate coding, a kind of joint coding, or a combination of separate coding and joint coding.

As shown in FIG. 16, the UCI coding part may be defined with HP HARQ-ACK as one unit and other UCIs as one unit (Pattern 1-8). Physically, HP HARQ-ACK is coded independently and HP CSI Unit 1, HP CSI Unit 2, LP CSI Unit 1 and LP CSI Unit 2 are coded integrally as one part. In other words, the UCI multiplexed in PUSCH is divided into two parts at one point. Such coding may be considered a kind of separate coding, a kind of joint coding, or a combination of separate coding and joint coding.

In Pattern 1-4 to Pattern 1-8, the UCI coding part may be defined based on both the priority of the UCI and the type of the UCI.

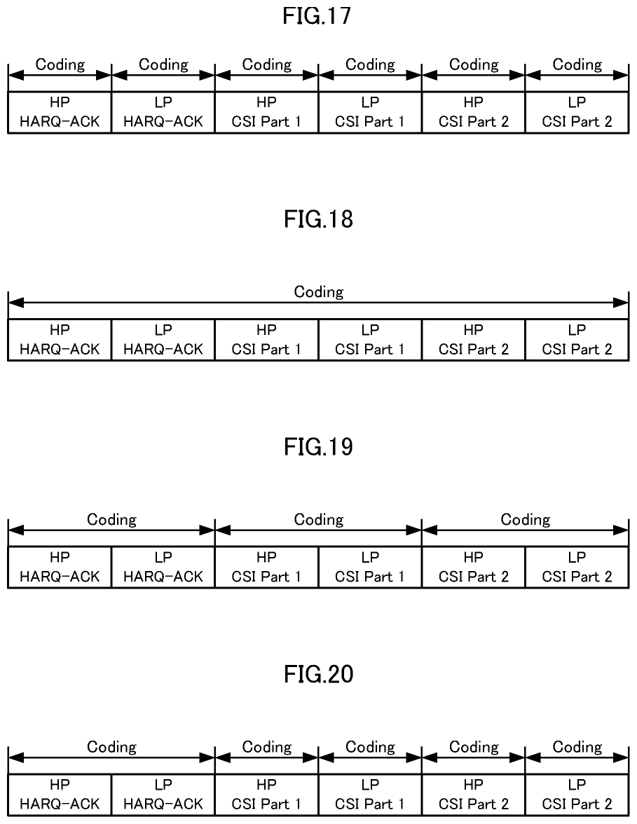

Second, the case where the UCI coding part is mainly defined based on each type of two or more UCIs multiplexed on the PUSCH will be described. In such a case, two or more UCIs are ordered based on the type of UCI and separated into UCI coding parts as shown in FIGS. 17 to 24. Specifically, UCIs multiplexed in PUSCH are ordered in the order of HP HARQ-ACK, LP HARQ-ACK, HP CSI Unit 1, LP CSI Unit 1, HP CSI Unit 2 and LP CSI Unit 1 and separated into UCI coding parts.

As shown in FIG. 17, UCI coding parts may be defined as a unit for each UCI (Pattern 2-1). Specifically, HP HARQ-ACK, LP HARQ-ACK, HP CSI Unit 1, LP CSI Unit 1, HP CSI Unit 2 and LP CSI Unit 1 are coded separately. That is, the UCI multiplexed on the PUSCH is divided into six parts with a maximum of five partitions. Such coding may be referred to as separate coding.

As shown in FIG. 18, the UCI coding part may be defined as all UCIs as one unit (Pattern 2-2). Specifically, HP HARQ-ACK, LP HARQ-ACK, HP CSI Unit 1, LP CSI Unit 1, HP CSI Unit 2 and LP CSI Unit 1 are coded integrally. That is, the UCI multiplexed in PUSCH is treated as one part without being separated. Such coding may be called joint coding.

As shown in FIG. 19, the UCI coding part may be defined as one unit for each type of UCI (Pattern 2-3). Specifically, HP HARQ-ACK and LP HARQ-ACK are integrally coded as one part, HP CSI Unit 1 and LP CSI Unit 1 are integrally coded as one part, and HP CSI Unit 2 and LP CSI Unit 1 are integrally coded as one part. In other words, the UCI multiplexed in PUSCH is divided into three parts with at most two separations. Such coding may be considered a kind of separate coding, a kind of joint coding, or a combination of separate coding and joint coding.

As shown in FIG. 20, the UCI coding part may be defined as HARQ-ACK as one unit, CSI Unit 1 and CSI Unit 2 as separate units, and CSI Unit 1 and CSI Unit 1 as separate units for each HP and LP priority (Pattern 2-4). Specifically, HP HARQ-ACK and LP HARQ-ACK are integrally coded as one part, and HP CSI Unit 1, LP CSI Unit 1, HP CSI Unit 2 and LP CSI Unit 1 are coded separately. That is, the UCI multiplexed on the PUSCH is divided into five parts with at most four separations. Such coding may be considered a kind of separate coding, a kind of joint coding, or a combination of separate coding and joint coding.

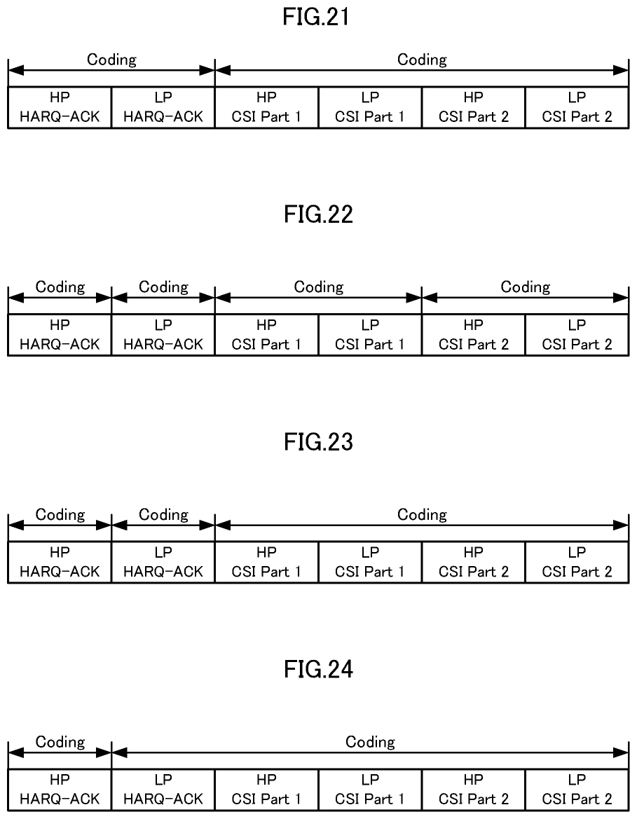

As shown in FIG. 21, the UCI coding part may be defined with HARQ-ACK as one unit and CSI Unit 1 and CSI Unit 2 as one unit (Pattern 2-5). Specifically, HP HARQ-ACK and LP HARQ-ACK are integrally coded as one part, and HP CSI Unit 1, LP CSI Unit 1, HP CSI Unit 2 and LP CSI Unit 1 are integrally coded as one part. In other words, the UCI multiplexed on the PUSCH is divided into two parts with a single division. Such coding may be considered a kind of separate coding, a kind of joint coding, or a combination of separate coding and joint coding.

As shown in FIG. 22, the UCI coding part is defined as a separate unit for each priority of HP and LP for HARQ-ACK, and may be defined as a separate unit for CSI Unit 1 and CSI Unit 1 regardless of the priority of HP and LP (Pattern 2-6). Specifically, HP HARQ-ACK and LP HARQ-ACK are coded separately, HP CSI Unit 1 and LP CSI Unit 1 are coded integrally as one part, and HP CSI Unit 2 and LP CSI Unit 1 are coded integrally as one part. That is, the UCI multiplexed in PUSCH is divided into four parts with a maximum of three separations. Such coding may be considered a kind of separate coding, a kind of joint coding, or a combination of separate coding and joint coding.

As shown in FIG. 23, the UCI coding part may be defined as a separate unit for each priority of HP and LP for HARQ-ACK, and CSI Unit 1 and CSI Unit 1 may be defined as a unit (Pattern 2-7). Specifically, HP HARQ-ACK and LP HARQ-ACK may be coded separately, and HP CSI Unit 1, LP CSI Unit 1, HP CSI Unit 2, and LP CSI Unit 1 may be coded integrally as a unit. In other words, the UCI multiplexed on the PUSCH may be divided into three parts with a maximum of two partitions. Such coding may be considered a type of separate coding, a type of joint coding, or a combination of separate coding and joint coding.

As shown in FIG. 23, the UCI coding part may be defined with HP HARQ-ACK as one unit and other UCIs as one unit (Pattern 2-8). Physically, HP HARQ-ACK is coded independently and LP HARQ-ACK, HP CSI Unit 1, LP CSI Unit 1, HP CSI Unit 2 and LP CSI Unit 1 are coded integrally as one part. In other words, the UCI multiplexed in PUSCH is divided into two parts with one division. Such coding may be considered a kind of separate coding, a kind of joint coding, or a combination of separate coding and joint coding.

In Pattern 2-4, Pattern 2-6 to Pattern 2-8, the UCI coding part may be defined based on both the priority of UCI and the type of UCI.

### (5) Specific Conditions

Specific conditions of the embodiment will be described below. The specific condition includes at least one of a condition using a predetermined UCI coding part, a condition using a UCI coding part specified by a radio resource control setting (The following RRC settings), and a condition using a UCI coding part specified by downlink control information (DCI). The specific condition may include the following options:
In option 1, the UCI coding part is predetermined in the radio communication system 10. In other words, the specific conditions may include conditions using the UCI coding part predetermined in the radio communication system 10. In option 1, the UCI coding part applied to UC200 is predetermined from Pattern 1-1 to Pattern 1-8 and Pattern 2-1 to Pattern 2-8 described above.
In option 2, the UCI coding part may be determined based on the RRC setting. In other words, the specific condition may include a condition that uses the UCI coding part specified based on the RRC setting. In option 2, the RRC setting specifies the UCI coding part to be applied to UC200 from the aforementioned Pattern 1-1 to Pattern 1-8 and Pattern 2-1 to Pattern 2-8.
In option 3, the UCI coding part may be determined based on the DCI. In other words, the specific condition may include a condition using the UCI coding part specified based on the DCI. In option 3, the UCI coding part applicable to UC200 is specified by the DCI from the above-mentioned Pattern 1-1 to Pattern 1-8 and Pattern 2-1 to Pattern 2-8.
In option 4, the UCI coding part may be determined based on the predetermined UCI coding part and the DCI. In other words, the specific conditions may include conditions using the predetermined UCI coding part and conditions using the UCI coding part specified based on the DCI. In option 4, the UCI coding part that can be specified by the DCI is predetermined from the aforementioned Pattern 1-1 to Pattern 1-8 and Pattern 2-1 to Pattern 2-8, and the UCI coding part that applies to UC200 is designated by the DCI from the predetermined Pattern.
In option 5, the UCI coding part may be determined based on the RRC setting and the DCI. In other words, the specific condition may include a condition that uses a UCI coding part specified based on the RRC setting and the DCI. In option 5, the RRC setting specifies a UCI coding part that can be specified by the DCI from among the aforementioned Pattern 1-1 to Pattern 1-8 and Pattern 2-1 to Pattern 2-8, and the DCI specifies a UCI coding part that applies to UC200 from among the Patterns specified by the RRC setting.
In option 6, the UCI coding part that applies to UC200 is selected from among the UCI coding parts specified in options 1 to 5 based on a specific rule. The specific rule may be set by RRC settings or may be predetermined in the radio communication system 10. The specific rule may include a first specific rule for UCI payload size and code rate, a second specific rule for encoder limits, or a third specific rule that is a combination of a first specific rule and a second specific rule.

### (5.1) First Specific Rule

The first specific rule relates to the payload size and code rate of the UCI. The first specific rule may be a rule that determines whether separate coding or joint coding is performed. The UE200 may execute separate coding when the condition related to the first specific rule (Separate coding condition) is satisfied, and may execute joint coding when the separate coding condition is not satisfied.

First, a case where the separate coding condition is a condition related to the payload of the LP UCI (Condition 1-1) will be described. For example, the separate coding condition may be that the size of the payload of the LP UCI is within a certain range. The certain range may be set or predetermined by an RRC message. The certain range may be LP UCI payload≥X₁, LP UCI payload≤X₂, or X₁≤SLP UCI payload≤X₂. A common certain range may be defined for all LP UCI types, and a separate certain range may be defined for each LP UCI.

Second, we describe a case where the separate coding condition is a condition on the payload of the HP UCI (Condition 1-2). For example, the separate coding condition may be that the size of the payload of the HP UCI is within a certain range. The specific range may be set by an RRC message or may be predetermined. The specific range may be HP UCI payload≥X₁, HP UCI payload≤X₂, or X₁≤SHP UCI payload≤X₂. A common specific range may be defined for all HP UCI types, and a separate specific range may be defined for each HP UCI.

Third, we describe a case where the separate coding condition is a condition for the payload of the LP UCI and the HP UCI (Condition 1-3). For example, the separate coding condition may be that the relative difference between the payload of the LP UCI and the payload of the HP UCI is within a specific range. The specific range may be set or predetermined by an RRC message. The specific range may be (HP UCI payload-LP UCI payload)≥X₁, (HP UCI payload-LP UCI payload)≤X₂, or X₁≤(HP UCI payload-LP UCI payload)≤X₂. The specific range may be (LP UCI payload-HP UCI payload)≥X₁, (LP UCI payload-HP UCI payload)≤X₂, or X₁≤(LP UCI payload-HP UCI payload)≤X₂. A common specific range may be defined for all multiple cases, and a separate specific range may be defined for each multiple case.

Fourth, a case where the separate coding condition is a condition related to the payload of LP UCI and HP UCI (Condition 1-4) will be described. For example, the separate coding condition may be that the ratio between the payload of LP UCI and the payload of HP UCI is within a specific range. The specific range may be set or predetermined by an RRC message. The specific range may be (HP UCI payload/LP UCI payload)≥N₁, (HP UCI payload/LP UCI payload)≤N₂, N₁≤(HP UCI payload/LP UCI payload)≤N₂. The specific range may be (LP UCI payload/HP UCI payload)≥N₁, (LP UCI payload/HP UCI payload)≤N₂, N₁≤(LP UCI payload/HP UCI payload)≤N₂. A common specific range may be defined for all multiple cases, and a separate specific range may be defined for each multiple case.

The UE200 may determine that the separate coding condition is satisfied when 1 or more conditions selected from the conditions 1-1 to 1-4 described above are satisfied. The conditions 1-1 to 1-4 need to be satisfied may be set by an RRC message or may be predetermined.

In addition, the payload of the LP UCI may be the payload before the partial drop or band ring is applied or the payload after the partial drop or band ring is applied.

Fifth, a case where the separate coding condition is a condition on the code rate of the LP UCI (Condition 2-1) will be described. For example, the separate coding condition may be that the code rate of the LP UCI is within a specific range. The specific range may be set or predetermined by an RRC message. The specific range may be LP UCI code rate≥r₁, LP UCI code rate≤r₂, or r₁≤SLP UCI code rate≤r₂. A common specific range may be defined for all LP UCI types, and a separate specific range may be defined for each LP UCI.

Sixth, a case where the separate coding condition is a condition related to the code rate of the HP UCI (Condition 2-2) will be described. For example, the separate coding condition may be that the HP UCI code rate is within a certain range. The certain range may be set or predetermined by an RRC message. The certain range may be HP UCI code rate≥r₁, HP UCI code rate≤r₂, or r₁≤SHP UCI code rate≤r₂. A common certain range may be defined for all HP UCI types, and a separate certain range may be defined for each HP UCI.

Seventh, a case where the separate coding condition is a condition on the code rate of LP UCI and HP UCI (Condition 2-3) will be described. For example, the separate coding condition may be that the relative difference between the code rate of LP UCI and that of HP UCI is within a specific range. The specific range may be set or predetermined by an RRC message. The specific range may be (HP UCI code rate-LP UCI code rate)≥r₁, (HP UCI code rate-LP UCI code rate)≤r₂, or r₁≤(HP UCI code rate-LP UCI code rate)≤r₂. The specific range may be (LP UCI code rate-HP UCI code rate) r₁, (LP UCI code rate-HP UCI code rate)≤r₂, or r₁≤(LP UCI code rate-HP UCI code rate)≤r₂. A common specific range may be defined for all multiplex cases, and a separate specific range may be defined for each multiplex case.

Eighth, a case where the separate coding condition is a condition on the code rate of LP UCI and HP UCI (Condition 2-4) will be described. For example, the separate coding condition may be that the relative difference between the code rate of LP UCI and that of HP UCI is within a specific range. The specific range may be set or predetermined by an RRC message. The specific range may be (HP UCI code rate/LP UCI code rate)≥N₁, (HP UCI code rate/LP UCI code rate)≤N₂, or N₁≤(HP UCI code rate/LP UCI code rate)≤N₂. The specific range may be (LP UCI code rate/HP UCI code rate)≥N₁, (LP UCI code rate/HP UCI code rate)≤N₂, or N₁≤(LP UCI code rate/HP UCI code rate)≤N₂. A common specific range may be defined for all multiple cases, and a separate specific range may be defined for each multiple case.

The UE200 may determine that the separate coding condition is satisfied when 1 or more conditions selected from the conditions 2-1 to 2-4 described above are satisfied. Which of the conditions from condition 2-1 to condition 2-4 needs to be satisfied may be set by the RRC message or may be predetermined.

In addition, the code rate of the LP UCI and the code rate of the HP UCI may be determined based on the target code rate used in the original HP/LP PUCCH resource. The code rate of the LP UCI and the code rate of the HP UCI may be determined based on the actual code rate used in the original HP/LP PUCCH resource.

Ninth, we describe a case where the separate coding condition is a condition for the payload of the LP UCI and the code rate of the LP UCI (Condition 3-1). For example, the separate coding condition may be that the ratio of the payload of the LP UCI to the code rate of the LP UCI is within a specific range. The specific range may be set or predetermined by an RRC message. The specific range may be (LP UCI payload/LP UCI code rate)≥p₁, (LP UCI payload/LP UCI code rate)≤p₂, or p₁≤(LP UCI payload/LP UCI code rate)≤p₂. A common specific range may be defined for all multiple cases, and a separate specific range may be defined for each multiple case.
10. A case where the separate coding condition is a condition related to the payload of the HP UCI and the code rate of the HP UCI (Condition 3-2) will be described. For example, the separate coding condition may be that the ratio of the payload of the HP UCI to the code rate of the HP UCI is within a certain range. The certain range may be set or predetermined by an RRC message. The certain range may be (HP UCI payload/HP UCI code rate)≥p₁, (HP UCI payload/HP UCI code rate)≤p₂, and p₁≤(HP UCI payload/HP UCI code rate)≤p₂. A common certain range may be defined for all multiple cases, and a separate certain range may be defined for each multiple case.
11. A case where the separate coding condition is a condition on the payload of the LP UCI and the code rate of the LP UCI (Condition 3-3) will be described. For example, the separate coding condition may be that the difference between the ratio of the payload of the LP UCI to the code rate of the LP UCI and the ratio of the payload of the LP UCI to the specific code rate is within a specific range. The specific range may be set or predetermined by an RRC message. The specific range may be {(LP UCI payload/certain code rate)−(LP UCI payload/LP UCI code rate)}≥p₁, {(LP UCI payload/certain code rate)−(LP UCI payload/LP UCI code rate)}≤p₂, and p₁≤{(LP UCI payload/certain code rate)−(LP UCI payload/LP UCI code rate)}≤p₂. The certain code rate may be determined based on the target code rate of the specific PUCCH resource or based on the code rate of the HP UCI. A common specific range may be determined for all LP UCI types or a separate specific range may be determined for each LP UCI.
12. A case where the separate coding condition is a condition on the payload of the HP UCI and the code rate of the HP UCI (Condition 3-4) will be described. For example, the separate coding condition may be that the difference between the ratio of the payload of the HP UCI to the code rate of the HP UCI and the ratio of the payload of the HP UCI to the certain code rate is within a certain range. The certain range may be set or predetermined by an RRC message. The specific range may be {(HP UCI payload/certain code rate)−(HP UCI payload/HP UCI code rate)}≥p₁, {(HP UCI payload/certain code rate)−(HP UCI payload/HP UCI code rate)}≤p₂, and p₁≤{(HP UCI payload/certain code rate)−(HP UCI payload/HP UCI code rate)}≤p₂. The certain code rate may be determined based on the target code rate of the particular PUCCH resource or based on the code rate of the LP UCI. A common specific range may be determined for all HP UCI types or a separate specific range may be determined for each HP UCI.

The UE200 may determine that the separate coding condition is satisfied when 1 or more conditions selected from the conditions 3-1 to 3-4 are satisfied. The conditions 3-1 to 3-4 need to be satisfied may be set by an RRC message or may be predetermined.

The payload of the LP UCI may be the payload before partial drop or band ring is applied or the payload after partial drop or band ring is applied.

In addition, the code rate of the LP UCI and the code rate of the HP UCI may be determined based on the target code rate used in the original HP/LP PUCCH resource. The code rate of the LP UCI and the code rate of the HP UCI may be determined based on the actual code rate used in the original HP/LP PUCCH resource.

Given this assumption, consider a case where Pattern 2-1 and Pattern 2-4 are specified by either Option 1 to Option 5. In such a case, the UE200 may decide to apply Pattern 2-1 if the separate coding condition is satisfied, and may decide to apply Pattern 2-4 if the separate coding condition is not satisfied.

For example, in a case where HP HARQ-ACK, HP CSI Unit 1, HP CSI Unit 2, and LP HARQ ACK are multiplexed on PUSCH, HP HARQ-ACK, LP HARQ-ACK, HP CSI Unit 1, and HP CSI Unit 2 may be coded separately if LP HARQ ACK payload≥X₁. On the other hand, if LP HARQ ACK payload≥X₁ is not present, HP HARQ-ACK and LP HARQ-ACK may be coded integrally as one unit, and HP CSI Unit 1 and HP CSI Unit 2 may be coded separately.

### (5.2) Second Specific Rule

The second specific rule is a rule concerning the limitation of the encoder. For example, the limitation of the encoder may be a limitation concerning the number of encoders that the UE200 has. The encoder may be read as a polar encoder.

In such a case, the above-mentioned Pattern 1-1 to Pattern 1-8 and Pattern 2-1 to Pattern 2-8 may be associated with an index in the order of the maximum number of encoders required by each Pattern. That is, the smaller the index, the larger the maximum number of encoders. In order of decreasing the index, the UE200 checks whether the number of encoders required for coding the UCI actually multiplexed on the PUSCH is sufficient in the Pattern associated with the index. If the number of encoders is insufficient, the UE200 performs a similar check by changing the index to a larger value. If the number of encoders is insufficient, the UE200 applies the Pattern associated with the index.

As described above, the second specific rule may be considered to be a rule that selects the Pattern for which the largest number of encoders is required within the range where the number of encoders required for coding the UCI actually multiplexed in the PUSCH is insufficient. The maximum number of encoders in the UE200 may be extended to a number greater than the maximum number specified in Release 16 (“3”).

Given this premise, consider a case in which Pattern 1-1, Pattern 1-4, and Pattern 2-3 are specified by one of options 1 through 5 when HP HARQ-ACK, HP CSI Unit 1, HP CSI Unit 2, and LP HARQ ACK are multiplexed on PUSCH. In such a case, assuming that the number of encoders of the UE200 is “3”, the UE200 determines that the number of encoders required by the Pattern 1-1 is insufficient, determines that the number of encoders required by the Pattern 1-4 is insufficient, and determines that the number of encoders required by the Pattern 2-3 is insufficient. That is, the UE200 applies the Pattern 2-3.

For example, in the case where the HP HARQ-ACK, HP CSI Unit 1, HP CSI Unit 2, and LP HARQ ACK are multiplexed on the PUSCH, if the number of encoders of the UE200 is assumed to be “3”, the HP HARQ-ACK and LP HARQ-ACK may be coded integrally as one unit, and the HP CSI Unit 1 and HP CSI Unit 2 may be coded separately.

### (5.3) Third Specific Rule

Third specific rule is a combination of first special rule and second specific rule. For example, the UE200 may select a subset of Pattern based on the first specific rule, and select a Pattern to be applied to the UE200 based on the second specific rule from the selected subset of Pattern. The subset of Pattern may be specified by RRC settings or may be predetermined in the radio communication system 10.

For example, when HP HARQ-ACK, HP CSI Unit 1, HP CSI Unit 2, and LP HARQ ACK are multiplexed on PUSCH, a subset #1 including Pattern 2-1, Pattern 2-6, and Pattern 2-7, and a subset #2 including Pattern 2-4 and Pattern 2-3 are specified by one of options 1 to 5. In such a case, UE200 selects subset #1 when the separate coding condition is satisfied, and selects subset #2 when the separate coding condition is not satisfied.

Assuming that the number of encoders in UE200 is “3” when subset #1 is selected, UE200 determines that the number of encoders required in Pattern 2-1 is insufficient, determines that the number of encoders required in Pattern 2-6 is insufficient, and determines that the number of encoders required in Pattern 2-7 is insufficient. That is, UE200 applies Pattern 2-7. In such a case, HP HARQ-ACK and LP HARQ ACK are coded separately, and HP CSI Unit 1 and HP CSI Unit 2 are coded integrally as one unit.

Assuming that the number of encoders in UE200 is “3” when subset #2 is selected, UE200 determines that the number of encoders required in Pattern 2-4 is insufficient, and then determines that the number of encoders required in Pattern 2-3 is insufficient. That is, UE200 applies Pattern 2-3. In such a case, HP HARQ-ACK and LP HARQ ACK are coded integrally as one unit, and HP CSI Unit 1 and HP CSI Unit 2 are coded separately.

### (6) Operational Effects

In an embodiment, UE200 determines the UCI coding part of 2 or more UCIs based on specific conditions when multiplexing 2 or more UCIs with different priorities into PUSCH. With this configuration, the UCI coding part of 2 or more UCIs can be appropriately determined by defining specific conditions.

### (7) Modification Example 1

A modification example 1 of the embodiment will be described below. In the following, the differences between the embodiments will be mainly described.

In modification example 1, a case in which the total resources of the UCI are limited by a scaling factor (αₑ) will be described. For example, the UCI resource limited by αₑ may be represented by:

$$⌈ {α}_{e} \cdot {\sum }_{l = 0}^{{N}_{symb , all}^{PUSCH} - 1} {M}_{s c}^{UCI} ( l ) ⌉ \qquad [ Equation 4 ]$$

N_{symb,all}^{PUSCH} is the total number of OFDM symbols of PUSCH including OFDM symbols for DMRS.

M_{sc}^{UCI}(l) is the number of code blocks of UL-SCH for PUSCH transmission.

αₑ is an example of the scaling factor multiplied to the radio resource (here, M_{sc}^{UCI}(l)) which can be used for the transmission of UCI. Here, in limiting the total resources of the UCI, the following values can be used as de.

First, αcommon, which is commonly set for all UCIs multiplexed in the PUSCH, may be defined as de. That is, one αcommon is used as de.

Second, as αₑ, a maximum value of a for each UCI multiplexed on the PUSCH, a minimum value of a for each UCI multiplexed on the PUSCH, or an average value of a for each UCI multiplexed on the PUSCH may be used. For example, in a case where UCI1, UCI2, and UCI3 are PUSCH multiplexed, max (α_{UCI1}, α_{UCI2}, α_{UCI3}), min (α_{UCI1}, α_{UCI2}, α_{UCI3}), or ave (α_{UCI1}, α_{UCI2}, α_{UCI3}) may be used as de.

Third, αₑ may be a specific parameter set by RRC. The specific parameter may be set by a combination of UCIs multiplexed on PUSCH. For example, in a case where UCI1, UCI2 and UCI3 are multiplexed on PUSCH, α_{UCI1_UCI2_UCI3} may be defined as the specific parameter.

In addition, the priority for each UCI coding part may be defined in a limitation on the total resources of the UCI. The priority of the UCI coding part may be set by the RRC based on the UCI type and PHY (physical layer) priority contained in the UCI coding part and may be predefined in the radio communication system 10. For example, if the priority of UCI coding unit 1 is higher than the priority of UCI coding unit 2, the second term for UCI coding unit 1 and UCI coding unit 2 may be expressed by the following equation:

$$\begin{matrix}UCI coding part 1 … ⌈ {α}_{e} \cdot {\sum }_{l = 0}^{{N}_{symb , all}^{PUSCH} - 1} {M}_{s c}^{UCI} ( l ) ⌉ \\ UCI coding part 2 … ⌈ {α}_{e} \cdot {\sum }_{l = 0}^{{N}_{symb , all}^{PUSCH} - 1} {M}_{s c}^{UCI} ( l ) ⌉ - {Q}_{part 1}^{′}\end{matrix} \qquad [ Equation 5 ]$$

Q′ₚₐᵣₜ₁ is the resource of UCI coding part 1.

### (8) Modification Example 2

A modification example 2 of the embodiment will be described below. Differences in the embodiment will be mainly described below.

In the modified example 2, a case in which the Pattern defining the UCI coding part is selected without considering the limitations of the encoder will be described. In such a case, a case in which the number of encoders actually required by the selected Pattern is larger than the number of encoders of UE200 can be considered. In such cases, the following options may be applied:
In option 1, the UE200 may reselect the Pattern defining the UCI coding part based on the encoder restriction rule, as in the second and third specific rules described above.
In option 2, the UE200 may drop the last UCI coding part in the order shown in FIGS. 9 to 16 or in the order shown in FIGS. 17 to 24 until the number of encoders actually required by the selected Pattern is less than or equal to the number of encoders of the UE200.
In option 3, the UE200 may bundle a specific UCI coding part into one UCI coding part until the number of encoders actually required by the selected Pattern is less than or equal to the number of encoders of the UE200. The specific UCI coding part may be the first UCI coding part in the order shown in FIG. 9 to 16 or 17 to 24 or the last UCI coding part in the order shown in FIG. 9 to 16 or 17 to 24.

For example, consider the case where HP HARQ-ACK, HP CSI Unit 1, HP CSI Unit 2 and LP HARQ-ACK are multiplexed, and Pattern 1-1 or Pattern 2-1 is selected based on the specific conditions and the first specific rule. Here, it is assumed that the number of encoders of the UC200 is “3”. According to the option 1 described above, re-selection of the Pattern defining the UCI coding part is performed based on the rules regarding the limitation of the encoder.

According to the option 2 described above, in Pattern 1-1, LP HARQ-ACK is dropped and HP HARQ-ACK, HP CSI Unit 1 and HP CSI Unit 2 are coded separately. On the other hand, in Pattern 2-1, HP CSI Unit 2 is dropped and HP HARQ-ACK, LP HARQ-ACK and HP CSI Unit 1 are coded separately.

In Option 3 described above, assuming that the last UCI coding part is bundled, in Pattern 1-1, LP HARQ-ACK is bundled with HP CSI Unit 2, HP HARQ-ACK and HP CSI Unit 1 are coded separately, and LP HARQ-ACK and HP CSI Unit 2 are coded integrally as one unit. On the other hand, in Pattern 2-1, HP CSI Unit 2 is bundled with HP CSI Unit 1, HP HARQ-ACK and LP HARQ-ACK are coded separately, and HP CSI Unit 1 and HP CSI Unit 2 are coded integrally as one unit.

### (9) Other Embodiments

Although the contents of the present invention have been described in accordance with the above embodiments, it is obvious to those skilled in the art that the present invention is not limited to these descriptions but can be modified and improved in various ways.

In the foregoing disclosure, a case in which two or more UCIs having different priorities are multiplexed on a PUSCH is illustrated. However, the foregoing disclosure is not limited thereto. The foregoing disclosure may also apply to the case of multiplexing two or more UCIs with different priorities into PUCCH.

Although not specifically mentioned in the foregoing disclosure, a Configured Grant (CG)-UCI may be included in the same UCI coding part as a HARQ-ACK with the same priority as a CG-UCI.

In the foregoing disclosure, the maximum number of encoders possessed by the UE200 may be extended to a number greater than the maximum number specified in Release 16 (“3”) and may be the same as the maximum number specified in Release 16 (“3”).

Although not specifically mentioned in the above disclosure, if a scheduling request (SR) is multiplexed with the above UCI, the SR may be included in the same UCI coding part as HARQ-ACK with the same priority as the SR, in the same UCI coding part as CSI Unit 1 with the same priority as the SR, and in the same UCI coding part as CSI Unit 2 with the same priority as the SR.

Although not specifically mentioned in the above disclosure, the application of any of the above options (For example, specific conditions and rules) may be set by upper layer parameters, reported by UE Capability in UE 200, or predetermined in the radio communication system 10. In addition, the application of any of the above options may be determined by upper layer parameters and UE Capability.

Here, UE Capability may include the following information elements: Specifically, UE Capability may include an information element indicating whether it supports the ability to multiplex UCIs of different priorities into PUSCH. UE Capability may include an information element indicating whether it supports the ability to multiplex HP UCIs and LPUCIs into PUSCH through multiple UCI coding parts. UE Capability may include an information element indicating whether it supports the ability to multiplex UCIs of different priorities into PUCCH. The UE Capability may include an information element indicating whether a plurality of UCI coding parts support the ability to multiplex HP UCI and LPUCI into PUCCH. The UE Capability may include an information element indicating whether a plurality of UCI coding parts support the ability to determine UCI coding parts by RRC configuration. The UE Capability may include an information element indicating whether a plurality of UCI coding parts support the ability to determine UCI coding parts by DCI. The UE Capability may include an information element indicating whether a plurality of UCI coding parts support the ability to determine UCI coding parts based on specific rules.

The block configuration diagrams (FIGS. 4 and 5) used to describe the embodiments described above illustrate blocks of functional units. Those functional blocks (structural components) can be realized by a desired combination of at least one of hardware and software. Means for realizing each functional block is not particularly limited. That is, each functional block may be implemented using a single device that is physically or logically coupled, or two or more devices that are physically or logically separated may be directly or indirectly (For example, using wire, wireless, etc.) connected and implemented using these multiple devices. The functional block may be implemented using the single device or the multiple devices combined with software.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that functions transmission is called a transmission unit (transmitting unit) or a transmitter. As described above, the method of realization of both is not particularly limited.

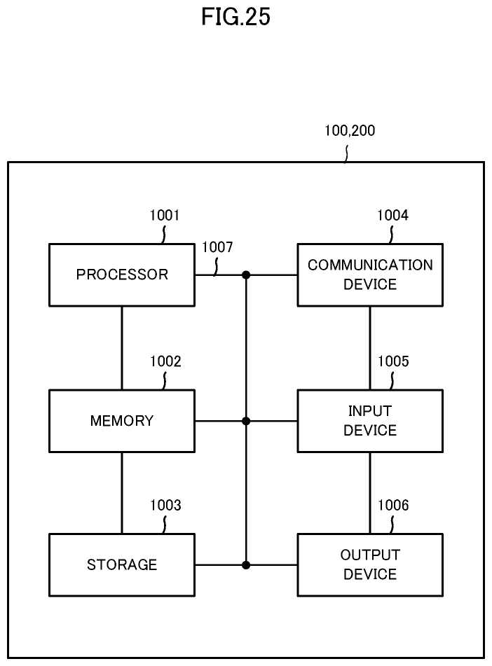

In addition, the above-mentioned gNB100 and UE200 (the device) may function as a computer for processing the radio communication method of the present disclosure. FIG. 25 is a diagram showing an example of a hardware configuration of the device. As shown in FIG. 25, the device may be configured as a computer device including a processor 1001, a memory 1002, a storage 1003, a communication device 1004, an input device 1005, an output device 1006 and a bus 1007.

Furthermore, in the following explanation, the term “device” can be replaced with a circuit, device, unit, and the like. The hardware configuration of the device may be configured to include one or more of the devices shown in the figure, or may be configured to include no part of the devices.

Each functional block of the device (see FIG. 4) is implemented by any hardware element of the computer device, or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

Processor 1001, for example, operates an operating system to control the entire computer. Processor 1001 may be configured with a central processing unit (CPU), including interfaces to peripheral devices, controls, computing devices, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Furthermore, the various processes described above may be performed by one processor 1001 or may be performed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), or the like. The memory 1002 may store programs (program codes), software modules, etc., which can execute the method according to one embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device, such as the processor 1001 and the memory 1002, is connected by a bus 1007 for communicating information. The bus 1007 may be configured using a single bus or a different bus for each device.

In addition, the device may be configured to include hardware such as a microprocessor, a digital signal processor (DSP), an application specific integrated circuit (ASIC), a programmable logic device (PLD), a field programmable gate array (FPGA), etc., which may provide some or all of each functional block. For example, the processor 1001 may be implemented by using at least one of these hardware.

Information notification is not limited to the aspects/embodiments described in the present disclosure and may be performed using other methods. For example, information notification may be performed by physical layer signaling (e.g., Downlink Control Information (DCI), Uplink Control Information (UCI), higher layer signaling (e.g., RRC signaling, Medium Access Control (MAC) signaling, Notification Information (Master Information Block (MIB), System Information Block (SIB)), other signals, or combinations thereof. RRC signaling may also be referred to as RRC messages, e.g., RRC Connection Setup messages, RRC Connection Reconfiguration messages, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc. of the embodiments/embodiments described in the present disclosure may be rearranged as long as there is no conflict. For example, the method described in the present disclosure presents the elements of the various steps using an exemplary sequence and is not limited to the particular sequence presented.

The specific operation that is performed by the base station in the present disclosure may be performed by its upper node in some cases. It is apparent that in a network consisting of one or more network nodes having a base station, the various operations performed for communication with the terminal may be performed by at least one of the base station and other network nodes (Examples include, but are not limited to, MME or S-GW.) other than the base station. In the above, an example in which there is one network node other than the base station is explained; however, a combination of a plurality of other network nodes (for example, MME and S-GW) may be used.

Information and signals (information, etc.) can be output from the upper layer (or lower layer) to the lower layer (or upper layer). It may be input and output via a plurality of network nodes.

The input/output information can be stored in a specific location (for example, a memory) or can be managed in a management table. The input/output information can be overwritten, updated, or added. The information can be deleted after outputting. The inputted information can be transmitted to another device.

The determination may be based on a value represented by a single bit (0 or 1), a true or false value (Boolean: true or false), or a numerical comparison (For example, comparison with a given value).

Each of the embodiments/embodiments described in the present disclosure may be used alone, in combination, or alternatively with execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when software is transmitted from a website, server, or other remote source using at least one of wire technology (Coaxial, fiber-optic, twisted-pair, and digital subscriber lines (DSL)) and wireless technology (Infrared, microwave, etc.), at least one of these wire technology and wireless technology is included within the definition of a transmission medium.

Information, signals, or the like mentioned above may be represented by using any of a variety of different technologies. For example, data, instructions, commands, information, signals, bits, symbols, chips, etc. that may be referred to throughout the above description may be represented by voltage, current, electromagnetic waves, magnetic fields or magnetic particles, light fields or photons, or any combination thereof.

The terms described in the present disclosure and those necessary for understanding the present disclosure may be replaced with terms having the same or similar meanings. For example, at least one of a channel and a symbol may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station may contain one or more (For example, three) cells, also called sectors. In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a base station performing communication services in this coverage and a portion or the entire coverage area of at least one of the base station subsystems.

In the present disclosure, the terms “mobile station (Mobile Station: MS),” “user terminal,” “user equipment (User Equipment: UE),” “terminal” and the like can be used interchangeably.

A mobile station may also be referred to by one of ordinary skill in the art as a subscriber station, mobile unit, subscriber unit, wireless unit, remote unit, mobile device, wireless device, radio communication device, remote device, mobile subscriber station, access terminal, mobile terminal, wireless terminal, remote terminal, handset, user agent, mobile client, client, or some other appropriate term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, planes, etc.), an unmanned mobile (For example, drones, self-driving cars,), or a robot (manned or unmanned). At least one of a base station and a mobile station can be a device that does not necessarily move during the communication operation. For example, at least one of a base station and a mobile station may be an Internet of Things (IOT) device such as a sensor.

The base station in the present disclosure may be read as a mobile station (user terminal, hereinafter the same). For example, each aspect/embodiment of the present disclosure may be applied to a configuration in which communication between a base station and a mobile station is replaced by communication between a plurality of mobile stations (For example, it may be called device-to-device (D2D), vehicle-to-everything (V2X), etc.). In this case, the mobile station may have the function of the base station. Further, words such as “up” and “down” may be replaced with words corresponding to communication between terminals (For example, “side”). For example, terms an uplink channel, a downlink channel, or the like may be read as a side channel.

Similarly, the mobile station in the present disclosure may be replaced with a base station. In this case, the base station may have the function of the mobile station.

The radio frame may be composed of one or more frames in the time domain. Each frame or frames in the time domain may be called a subframe. The subframes may also be composed of one or more slots in the time domain. The subframes may be of a fixed time length (For example, 1 ms) independent of numerology.

The numerology may be a communication parameter applied to at least one of the transmission and reception of a signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like. The slot may consist of one or more symbols (Orthogonal Frequency Division Multiplexing (OFDM)) symbols, Single Carrier Frequency Division Multiple Access (SC-FDMA) symbols, etc., in the time domain. A slot may be a unit of time based on the numerology.

A slot may include a plurality of minislots. Each minislot may consist of one or more symbols in the time domain. A minislot may also be called a subslot. A minislot may be composed of fewer symbols than slots. PDSCH (or PUSCH) transmitted in units of time greater than the minislot may be referred to as PDSCH (or PUSCH) mapping type A. PDSCH (or PUSCH) transmitted using the minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be referred to as a transmission time interval (TTI), a plurality of consecutive subframes may be referred to as a TTI, and one slot or minislot may be referred to as a TTI. That is, at least one of the subframes and the TTI may be a subframe in an existing LTE (1 ms), a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called a TTI, one or more TTIs (That is, one or more slots or one or more minislots) may be the minimum time unit for scheduling. The number of slots constituting the minimum time unit for scheduling (the number of minislots) may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTIs shorter than the normal TTI may be referred to as shortened TTI, short TTI, partial or fractional TTI, shortened subframe, short subframe, minislot, subslot, slot, etc.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

A resource block (RB) is a time domain and frequency domain resource allocation unit and may include one or more consecutive subcarriers in the frequency domain. The number of subcarriers included in RB may be, for example, twelve, and the same regardless of the topology. The number of subcarriers included in the RB may be determined based on the neurology.

The time domain of the RB may also include one or more symbols and may be one slot, one minislot, one subframe, or one TTI in length. The one TTI, one subframe, and the like may each consist of one or more resource blocks.

The one or more RBs may be called physical resource blocks (PRBs), sub-carrier groups (SCGs), resource element groups (REGs), PRB pairs, RB pairs, and the like.

The resource block may be composed of one or more resource elements (REs). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by the index of the RB relative to the common reference point of the carrier. PRB may be defined in BWP and numbered within that BWP.

BWP may include UL BWP (UL BWP) and DL BWP (DL BWP). For the UE, one or more BWPs may be set in one carrier.

At least one of the configured BWPs may be active, and the UE may not expect to send and receive certain signals/channels outside the active BWP. Note that “cell,” “carrier,” and the like in the present disclosure may be read as “BWP.”

The above-described structures such as a radio frame, subframe, slot, minislot, and symbol are merely examples. For example, the number of subframes included in the radio frame, the number of slots per subframe or radio frame, the number of minislots included in the slot, the number of symbols and RBs included in the slot or minislot, the number of subcarriers included in the RB, and the number of symbols in the TTI, the symbol length, the cyclic prefix (CP) length, and the like can be varied.

The terms “connected” and “coupled,” or any variation thereof, mean any direct or indirect connection or coupling between two or more elements and can include the presence of one or more intermediate elements between two elements “connected” or “coupled” to each other. The connection or coupling between elements may be physical, logical, or a combination thereof. For example, “connection” may be read as “access.” As used in the present disclosure, the two elements can be considered to be “connected” or “coupled” to each other using at least one of one or more wire, cable, and printed electrical connections and, as some non-limiting and non-inclusive examples, electromagnetic energy having wavelengths in the radio frequency, microwave, and optical (both visible and invisible) regions.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

No reference to elements using designations such as “first” and “second” as used in the present disclosure generally limits the quantity or order of those elements. Such designations can be used in the present disclosure as a convenient way to distinguish between two or more elements. Accordingly, reference to the first and second elements does not imply that only two elements may be employed therein, or that the first element must in any way precede the second element.

In the present disclosure, the used terms “include,” “including,” and variants thereof are intended to be inclusive in a manner similar to the term “comprising.” Furthermore, it is intended that the term “or (or)” as used in the present disclosure is not an exclusive OR.

Throughout the present disclosure, for example, during translation, if articles such as a, an, and the in English are added, in the present disclosure, these articles shall include plurality of nouns following these articles.

As used in the present disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgment” and “decision” may include regarding some action as “judgment” and “decision.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 Radio communication system
20 NG-RAN
100 gNB
110 Reception unit
120 Transmission unit
130 Control unit
200 UE
210 Radio signal transmission and reception unit
220 Amplifier unit
230 Modulation and demodulation unit
240 Control signal and reference signal processing unit
250 Encoding/decoding unit
260 Data transmission and reception unit
270 Control unit
1001 Processor
1002 Memory
1003 Storage
1004 Communication device
1005 Input device
1006 Output device
1007 Bus

1. A terminal comprising:
a control unit that multiplexes two or more uplink control information having different priorities on an uplink channel; and
a communication unit that transmits an uplink signal using the uplink channel on which the two or more uplink control information is multiplexed,
wherein the control unit determines a coding unit of the two or more uplink control information based on a specific condition.

2. The terminal of claim 1, wherein the coding unit is defined based on at least one of respective priorities of the two or more uplink control information and respective types of the two or more uplink control information.

3. The terminal of claim 1, wherein the specific condition comprises at least one of a condition using a predetermined coding unit, a condition using a coding unit specified by a radio resource control setting, and a condition using a coding unit specified by downlink control information.

4. A radio communication system comprising:
a terminal; and
a base station,
wherein the terminal comprises:
a control unit that multiplexes two or more uplink control information having different priorities on an uplink channel; and
a communication unit that transmits an uplink signal using the uplink channel on which the two or more uplink control information is multiplexed,
wherein the control unit determines a coding unit of the two or more uplink control information based on a specific condition.

5. A radio communication method comprising:
a step A of multiplexing two or more uplink control information having different priorities on an uplink channel; and
a step B of transmitting an uplink signal using the uplink channel on which the two or more uplink control information is multiplexed,
wherein the step A includes a step of determining a coding unit of the two or more uplink control information based on a specific condition.

6. The terminal of claim 2, wherein the specific condition comprises at least one of a condition using a predetermined coding unit, a condition using a coding unit specified by a radio resource control setting, and a condition using a coding unit specified by downlink control information.
